(19) United States
(12) Patent Application Publication
(10) Pub. No.: US 2025/0304051 A1
(43) Pub. Date: Oct. 2, 2025

(54) VEHICLE CONTROL APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kento OISHI, Tokyo (JP); Takuma SUZUKI, Mishima-shi (JP)

(21) Appl. No.: 19/089,824

(22) Filed: Mar. 25, 2025

(30) Foreign Application Priority Data
Mar. 28, 2024 (JP) 2024-052972

(51) Int. Cl. B60W 30/09; B60W 30/095

(52) U.S. Cl. CPC B60W 30/09; B60W 30/0953; B60W 30/0956; B60W 2520/14; B60W 2540/18; B60W 2552/53

(57) ABSTRACT

A vehicle control apparatus is mounted to a vehicle that includes an object detection unit that detects an object in a vicinity of the vehicle, an anti-collision apparatus that controls the vehicle to suppress a collision between the vehicle and the object, and a lane detection unit that detects a boundary line demarcating a traffic lane ahead of the vehicle. The vehicle control apparatus does not restrict operation of the anti-collision apparatus in response to an execution condition being met, and performs control restriction restricting operation of the anti-collision apparatus in response to a restriction condition being met. The execution condition includes a divided roadway condition being met. The divided roadway condition is a width of the traffic lane determined based on the boundary line being less than a width of a traffic lane permitting two-way traffic. The restriction condition includes the divided roadway condition not being met.

### CROSS-REFERENCE TO RELATED APPLICATIONS

This application is based on and claims the benefit of priority from Japanese Patent Application No. 2024-052972, filed on Mar. 28, 2024. The entire disclosure of the above application is incorporated herein by reference.

### BACKGROUND

The present disclosure relates to a vehicle control apparatus. In vehicle control apparatuses in which an anti-collision apparatus is mounted, there is a technology in which the anti-collision apparatus is controlled based on turning of an own vehicle. The vehicle control apparatus suppresses unnecessary operation of the anti-collision apparatus by determining transition from a straight-ahead state to a turning state.

### SUMMARY

An aspect of the present disclosure provides a vehicle control apparatus that is mounted to a vehicle. The vehicle includes an object detection unit that detects an object in a vicinity of the vehicle, an anti-collision apparatus that controls the vehicle to suppress a collision between the vehicle and the object resulting from the vehicle moving, and a lane detection unit that detects a boundary line demarcating a traffic lane ahead of the vehicle. The vehicle control apparatus does not restrict operation of the anti-collision apparatus in response to an execution condition being met, and performs control restriction restricting operation of the anti-collision apparatus in response to a restriction condition being met. The execution condition includes a divided roadway condition being met. The divided roadway condition is a width of the traffic lane determined based on the boundary line detected by the lane detection unit being less than a width of a traffic lane permitting two-way traffic. The restriction condition includes the divided roadway condition not being met.

### BRIEF DESCRIPTION OF THE DRAWINGS

In the accompanying drawings:

FIG. 1 is an explanatory diagram illustrating a configuration according to a first embodiment;

FIG. 2 is an explanatory diagram illustrating a first travel example of an own vehicle;

FIG. 3 is a flowchart illustrating a control method of a vehicle control apparatus according to the first embodiment;

FIG. 4 is a flowchart illustrating a determination process for a restriction condition according to the first embodiment;

FIG. 5 is an explanatory diagram illustrating a second travel example of the own vehicle;

FIG. 6 is a flowchart illustrating a determination process for operation of an anti-collision apparatus;

FIG. 7 is a flowchart illustrating a determination process for a restriction condition according to a second embodiment;

FIG. 8 is a flowchart illustrating a determination process for a restriction condition according to a third embodiment;

FIG. 9 is a flowchart illustrating a control method of a vehicle control apparatus according to a fourth embodiment;

FIG. 10 is a flowchart illustrating a determination process for turning at an intersection;

FIG. 11 is an explanatory diagram illustrating a fourth travel example of the own vehicle;

FIG. 12 is an explanatory diagram illustrating a fifth travel example of the own vehicle;

FIG. 13 is an explanatory diagram illustrating a sixth travel example of the own vehicle;

FIG. 14 is an explanatory diagram illustrating a seventh travel example of the own vehicle;

FIG. 15 is a flowchart illustrating a control method of a vehicle control apparatus according to a fifth embodiment; and

FIG. 16 is an explanatory diagram illustrating an example of a center two-way left-turn lane used in the United States, as a mode that can be determined to be a divided roadway (arterial road) by a vehicle control apparatus according to another embodiment.

### DESCRIPTION OF THE EMBODIMENTS

In a vehicle control apparatus in which an anti-collision apparatus is mounted, as described in JP 2022-027066 A, there is a technology in which the anti-collision apparatus is controlled based on turning of an own vehicle. More specifically, the vehicle control apparatus in JP 2022-027066 A suppresses unnecessary operation of the anti-collision apparatus by determining transition from a straight-ahead state to a turning state. Here, the anti-collision apparatus automatically operates braking of the own vehicle, warning to a driver, and the like. “Unnecessary operation” refers to the anti-collision apparatus operating in a situation in which operation of the anti-collision apparatus is unnecessary. “Non-operation (failure to operate),” described hereafter, refers to the anti-collision apparatus failing to operate in a situation in which operation of the anti-collision apparatus is necessary.

The inventors have developed a vehicle control apparatus that, by determining the transition from the straight-ahead state to the turning state, sets the anti-collision apparatus to an operable state during turning of the vehicle at an intersection. Here, the transition from the straight-ahead state to the turning state is, for example, determined based on a steering angle or a yaw rate of the vehicle. However, in cases in which the vehicle moves unsteadily or turns before entering the intersection, the anti-collision apparatus may fail to operate at the intersection as a result of the vehicle being determined to not be in the straight-ahead state. Here, for example, the vehicle moves unsteadily or turns before entering the intersection in cases in which the vehicle changes traffic lanes before entering the intersection or enters a road before entering the intersection.

It is thus desired to appropriately operate an anti-collision apparatus based on traveling conditions of an own vehicle.

The present disclosure can be implemented according to embodiments below.

An exemplary embodiment of the present disclosure provides a vehicle control apparatus that is mounted to a vehicle. The vehicle includes an object detection unit that detects an object in a vicinity of the vehicle, an anti-collision apparatus that controls the vehicle to suppress a collision between the vehicle and the object resulting from the vehicle moving, and a lane detection unit that detects a boundary line demarcating a traffic lane ahead of the vehicle. The vehicle control apparatus does not restrict operation of the anti-collision apparatus in response to an execution condition being met, and performs control restriction restricting operation of the anti-collision apparatus in response to a restriction condition being met. The execution condition includes a divided roadway condition being met. The divided roadway condition is a width of the traffic lane determined based on the boundary line detected by the lane detection unit being less than a width of a traffic lane permitting two-way traffic. The restriction condition includes the divided roadway condition not being met.

According to this exemplary embodiment, the vehicle control apparatus of the present disclosure restricts operation of the anti-collision apparatus by restriction control. The vehicle control apparatus of the present disclosure can suppress unnecessary operation of the anti-collision apparatus when the divided roadway condition is not met. In addition, the vehicle control apparatus of the present disclosure can suppress non-operation when the divided roadway condition is met. Consequently, the vehicle control apparatus of the present disclosure can appropriately operate the anti-collision apparatus based on traveling conditions of the vehicle.

### A. First Embodiment

### A-1. Configuration According to a First Embodiment

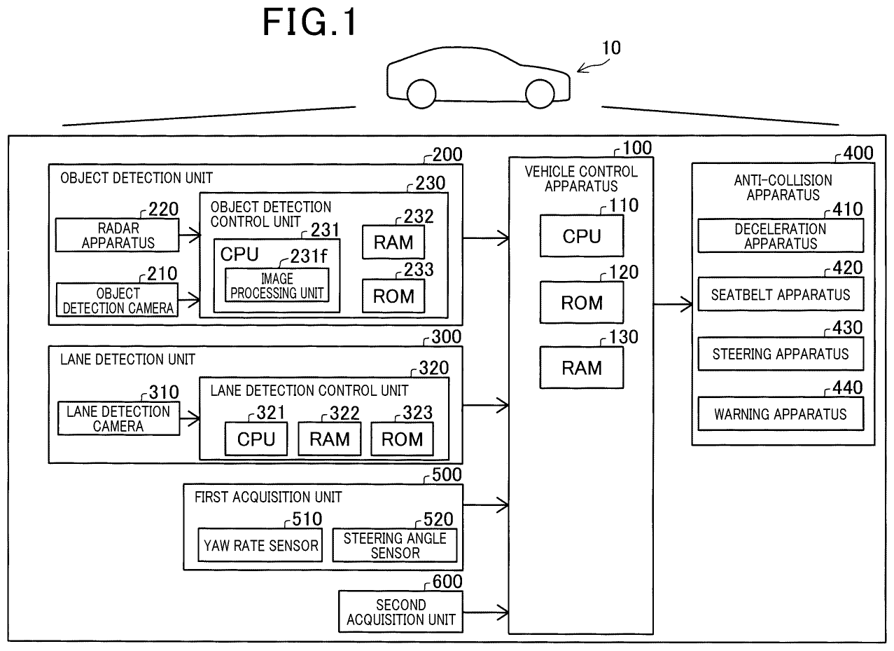

A vehicle control apparatus 100 shown in FIG. 1 is mounted to a vehicle 10. A driving apparatus for accelerating the vehicle 10, a steering apparatus 430 for changing an advancing direction of the vehicle 10, and a braking apparatus 410 for decelerating the vehicle 10 are mounted to the vehicle 10. In the description below, the vehicle 10 is also referred to as an own vehicle 10. In addition, a vehicle other than the vehicle 10 is referred to as another vehicle Ve. Here, in FIG. 1, the driving apparatus is omitted from the drawing to facilitate understanding of the technology.

The own vehicle 10 further includes the vehicle control apparatus 100, an object detection unit 200, a lane detection unit 300, an anti-collision apparatus 400, a first acquisition unit 500, and a second acquisition unit 600.

The first acquisition unit 500 acquires measurement values that are a steering angle and a yaw rate of the own vehicle 10. The first acquisition unit 500 includes a yaw rate sensor 510 and a steering angle sensor 520. For example, the yaw rate sensor 510 may be disposed in a center portion of the vehicle 10. The yaw rate sensor 510 acquires a rotational angular velocity of the own vehicle 10. The steering angle sensor 520 acquires a steering angle of a steering unit of a steering apparatus. For example, the steering angle sensor 520 may be attached to a steering rod of the own vehicle 10.

The second acquisition unit 600 acquires a vehicle speed that is a traveling speed of the own vehicle 10. Specifically, the second acquisition unit 600 is a vehicle speed sensor. The second acquisition unit 600 is attached to a wheel and acquires the vehicle speed based on a rotational speed of the wheel.

The object detection unit 200 detects an object Ob in a vicinity of the own vehicle 10. The object detection unit 200 includes an object detection camera 210, a radar apparatus 220, and an object detection control unit 230. Here, the object Ob is not limited to the vehicle 10. For example, the object Ob may be another vehicle Ve, a person H, a bicycle, a motorcycle, an electric kick scooter, or the like.

The object detection camera 210 captures images of the vicinity of the own vehicle 10. For example, the object detection camera 210 may be provided to face ahead of the own vehicle 10, as well as a leftward direction and a rightward direction. More specifically, the object detection camera 210 is configured by four monocular cameras. The four monocular cameras are provided in an upper portion of a front windshield, near a rear bumper, and left and right side mirrors of the own vehicle 10.

The radar apparatus 220 acquires a relative distance from the own vehicle 10 to the object Ob in the vicinity of the own vehicle 10. For example, in a manner similar to the object detection camera 210, the radar apparatus 220 may be provided to face ahead of the own vehicle 10, as well as the leftward direction and the rightward direction. The radar apparatus 220 emits millimeter waves and acquires a position and a distance of the object Ob by receiving reflected waves reflected by the object Ob. Furthermore, the radar apparatus 220 acquires an orientation from the own vehicle 10 toward the object Ob. The radar apparatus 220 acquires the orientation from the own vehicle 10 to the object Ob based on phase differences in the reflected waves received by a plurality of antennas. That is, the radar apparatus 220 acquires a relative position based on the relative distance and the orientation of the object Ob in the vicinity of the own vehicle 10.

The radar apparatus 220 further acquires a relative speed of the object Ob in the vicinity of the own vehicle 10. The radar apparatus 220 acquires the relative speed from a frequency of the reflected wave reflected by the object Ob that changes as a result of the Doppler effect.

The object detection control unit 230 controls the object detection unit 200. The object detection control unit 230 is configured as a logic circuit mainly composed of a microcomputer. More specifically, the object detection control unit 230 includes a central processing unit (CPU) 231, a read-only memory (ROM) 233, and a random access memory (RAM) 232. The CPU 231 runs a control program set in advance. The ROM 233 stores therein, in advance, a control program, control data, and the like required for the CPU 231 to perform various calculation processes. Various types of data required for the CPU 231 to perform the various calculation processes are temporarily written to and read from the RAM 232. The CPU 231 includes a functional unit of an image processing unit 231f. The object detection control unit 230 sends acquired information to the vehicle control apparatus 100.

The image processing unit 231f calculates the relative distance and the orientation to the object Ob in the vicinity of the own vehicle 10 based on the image captured by the object detection camera 210. That is, the image processing unit 231f measures a relative position based on the relative distance and the orientation of the object Ob in the vicinity of the own vehicle 10.

The image processing unit 231f calculates the relative speed of the object Ob in the vicinity of the own vehicle 10 by an optical flow method. In the optical flow method, an orientation of a vector related to movement of the object Ob is estimated from positional changes in feature points of the object B between frames of the captured images. As a result, the image processing unit 231f acquires the relative speed of the object Ob in the vicinity of the own vehicle 10. Furthermore, the image processing unit 231f determines a movement path of the object Ob in the vicinity of the own vehicle 10 based on the relative position and the relative speed.

The lane detection unit 300 detects a boundary line BL defining a traffic lane L ahead of the own vehicle 10. The lane detection unit 300 includes a lane detection camera 310 and a lane detection control unit 320.

The lane detection camera 310 captures images of the traffic lane L ahead of the own vehicle 10. For example, the lane detection camera 310 may be provided in the upper portion of the front windshield to be capable of capturing images of the traffic lane ahead of the own vehicle 10. For example, the lane detection camera 310 may be configured by a single monocular camera.

The lane detection control unit 320 controls the lane detection unit 300. The lane detection control unit 320 is configured as a logic circuit mainly composed of a microcomputer, in a manner similar to the object detection control unit 230. That is, the lane detection control unit 320 includes a CPU 321, a RAM 322, and a ROM 323. More specifically, the lane detection control unit 320 detects the boundary line BL defining the traffic lane L based on color, shape, orientation, and the like in the captured image. The lane detection control unit 320 acquires presence/absence of the traffic lane L and a width W of the traffic lane L as a detection result. The lane detection control unit 320 sends the detection result to the vehicle control apparatus 100.

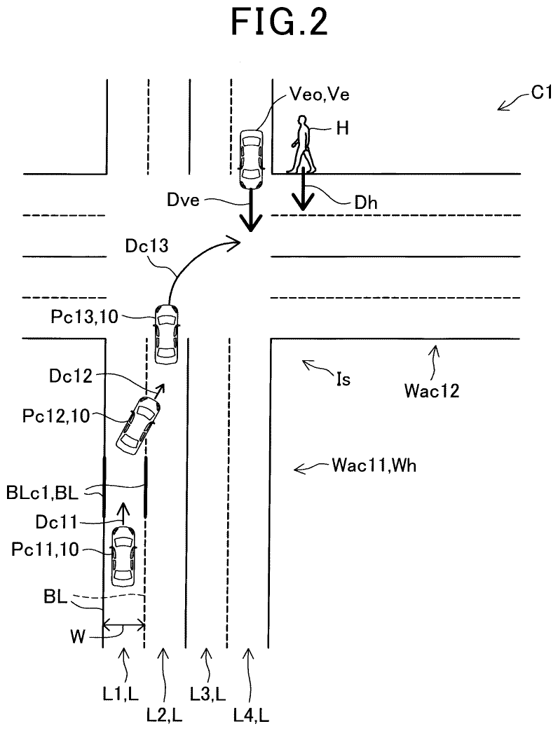

In a first travel example C1 of the own vehicle 10 shown in FIG. 2, a first road Wac11 having four traffic lanes L is shown. The first road Wac11 in FIG. 2 is configured by two traffic lanes in each direction, the traffic lanes being a pair composed of a first lane L1 and a second lane L2, and a pair composed of a third lane L3 and a fourth lane L4. Each traffic lane L is defined by the boundary lines L that are solid or broken lines. Here, the boundary line L on an actual road may be, for example, a white broken line, a white solid line, a yellow solid line, or a yellow broken line. That is, a distance between the boundary lines BL is a width W of the traffic lane L. The lane detection unit 300 acquires the traffic lane L and the width W of the traffic lane L as shown in FIG. 2 as the detection result. Here, the first road Wac11 is included in an arterial road Wh in the present specification. The arterial road Wh and FIG. 2 will be described in detail hereafter.

The anti-collision apparatus 400 controls the own vehicle 10 to suppress a collision between the own vehicle 10 and the object Ob resulting from the own vehicle 10 advancing. The anti-collision apparatus 400 includes a deceleration apparatus 410, a seatbelt apparatus 420, a steering apparatus 430, and a warning apparatus 440. The deceleration apparatus 410 decelerates the own vehicle 10 in response to a command for anti-collision from the vehicle control apparatus 100. The seatbelt apparatus 420 winds a seatbelt in response to the command for anti-collision from the vehicle control apparatus 100. As a result, the seatbelt apparatus 420 more firmly restrains a passenger to a seat, compared to when the command for anti-collision is not received. The warning apparatus 440 notifies the driver that a collision may occur in response to the command for anti-collision from the vehicle control apparatus 100. For example, the warning apparatus 440 may include a speaker or an illumination apparatus and notifies the driver of the likelihood of a collision by audio and/or visual means (e.g., sound and/or light). The steering apparatus 430 adjusts the orientation of the own vehicle 10 to avoid a collision with the object Ob in response to the command for anti-collision from the vehicle control apparatus 100.

The vehicle control apparatus 100 controls the own vehicle 10. The vehicle control apparatus 100 is configured as a logic circuit mainly composed of a microcomputer, in a manner similar to the object detection control unit 230 and the lane detection control unit 320. That is, the vehicle control apparatus 100 includes a CPU 110, a RAM 120, and a ROM 130. Functions of the vehicle control apparatus 100 will be described below.

### A-2. Control Method of the Vehicle Control Apparatus

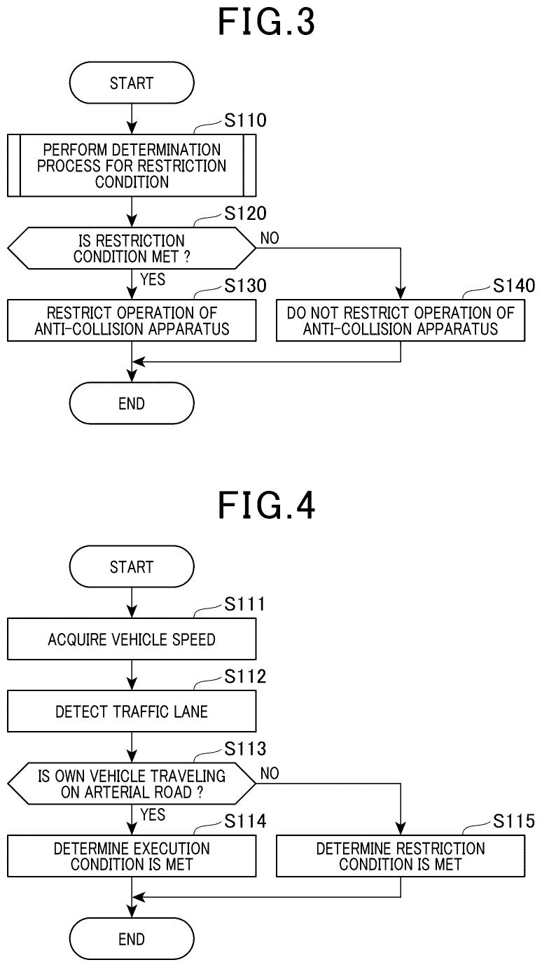

The vehicle control apparatus 100 controls the anti-collision apparatus 400 by a process shown in FIG. 3. The vehicle control apparatus 100 repeatedly performs the process below while the own vehicle 10 is traveling.

At step S110 in FIG. 3, the vehicle control apparatus 100 performs a determination process for a restriction condition. Here, the restriction condition is a condition under which restriction control to restrict operation of the anti-collision apparatus 400 is performed.

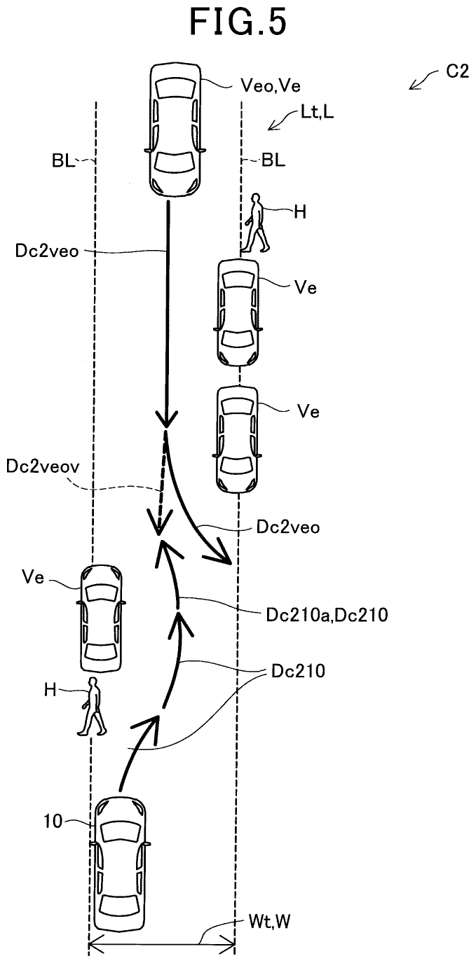

The vehicle control apparatus 100 performs the determination process for the restriction condition shown in FIG. 4. At step S111 in FIG. 4, the vehicle control apparatus 100 acquires the vehicle speed by the second acquisition unit 600.

At step S112 in FIG. 4, the vehicle control apparatus 100 detects the traffic lane L ahead of the own vehicle 10 by the lane detection unit 300. More specifically, the vehicle control apparatus 100 acquires the width W of the traffic lane L as the detection result when the boundary line BL ahead of the own vehicle 10 can be detected. Here, the vehicle control apparatus 100 acquires absence of the boundary line BL as the detection result when the boundary line BL ahead of the own vehicle 10 cannot be detected.

Here, the vehicle control apparatus 100 sets the boundary line BL meeting a reference length as a condition for detection of the boundary line BL. The reference length is set based on the vehicle speed. If the reference length is fixed, the lane detection unit 300 less easily detects the boundary line BL as the vehicle speed increases. Therefore, the reference length is set to be longer as the vehicle speed increases and shorter as the vehicle speed decreases. For example, a relationship between the vehicle speed and the reference length may be experimentally set based on the vehicle speed at which the lane detection unit 300 is able to detect the boundary line BL.

At step S113 in FIG. 4, the vehicle control apparatus 100 determines whether the own vehicle 10 is traveling on the arterial road Wh. More specifically, the vehicle control apparatus 100 determines whether a divided roadway condition is met. The divided roadway condition is that the width W of the traffic lane L determined based on the boundary line BL detected by the lane detection unit 300 be less than the width W of a traffic lane L permitting two-way traffic. The traffic lane L permitting two-way traffic is also referred to as a two-way roadway Lt.

A process performed when the divided roadway condition is met will be described using a second travel example C2 of the own vehicle 10 shown in FIG. 5. As shown in FIG. 5, in the two-way roadway Lt, the boundary lines BL may be drawn on both sides of the road without a center line. A state of the second travel example C2 will be described in detail hereafter. A width Wt of the traffic lane L in the two-way roadway is specifically 4 m. The divided roadway condition that the width W of the traffic lane L be less than the width Wt of the traffic lane L in the two-way roadway is specifically that the boundary line BL be detected and the width W of the traffic lane L be less than 4 m. Here, the width Wt of the traffic lane L is not limited to 4 m. For example, standards regarding lane width, steering angle, and the like may be changed depending on road traffic circumstances in each country.

In the arterial road Wh, such as a national highway or an expressway, in many cases, the boundary lines BL and the center line are drawn, and one-way traffic is clearly indicated by the boundary lines BL. Here, FIG. 2 shows an example of the arterial road Wh. In the arterial road Wh, the width W of the traffic lane L is generally prescribed to be equal to or less than 3.5 m. That is, the width W of the traffic lane L in the arterial road Wh is less than the width Wt of the traffic lane L in the two-way roadway. Therefore, when the divided roadway condition is met, the own vehicle 10 is highly likely to be traveling on the arterial roadway Wh. When determined that the divided roadway condition is met, the vehicle control apparatus 100 advances the process to step S114.

A case in which the divided roadway condition is not met is a case in which the width W of the traffic lane L is the width Wt of the traffic lane L in the two-way roadway or the boundary line BL is not detected. When determined that the divided roadway condition is not met, the vehicle control apparatus 100 advances the process to step S115.

At step S114 in FIG. 4, the vehicle control apparatus 100 determines that the traffic lane L ahead of the own vehicle 10 meets an execution condition. The execution condition is a condition under which the anti-collision apparatus 400 is set to an operable state and includes the divided roadway condition being met.

At step S115 in FIG. 4, the vehicle control apparatus 100 determines that the traffic lane L ahead of the own vehicle 10 meets the restriction condition. The restriction condition includes the divided roadway condition not being met.

The determination process for the restriction condition is then ended. The process returns to the flowchart in FIG. 3.

At step S120 in FIG. 3, the vehicle control apparatus 100 determines whether the restriction condition is met. When determined that the restriction condition is met, the vehicle control apparatus 100 advances the process to step S130. When not determined that the execution condition is met, the vehicle control apparatus 100 advances the process to step S140.

At step S130 in FIG. 3, the vehicle control apparatus 100 restricts operation of the anti-collision apparatus 400. For example, when restricting the operation of the anti-collision apparatus 100, the vehicle control apparatus 100 may set a collision determination condition to be stricter than when not restricting the operation of the anti-collision apparatus 400. The collision determination condition will be described hereafter.

At step S140 in FIG. 3, the vehicle control apparatus 100 does not restrict the operation of the anti-collision apparatus 400. Here, when the operation of the anti-collision apparatus 400 is already restricted, the vehicle control apparatus 100 releases the restriction.

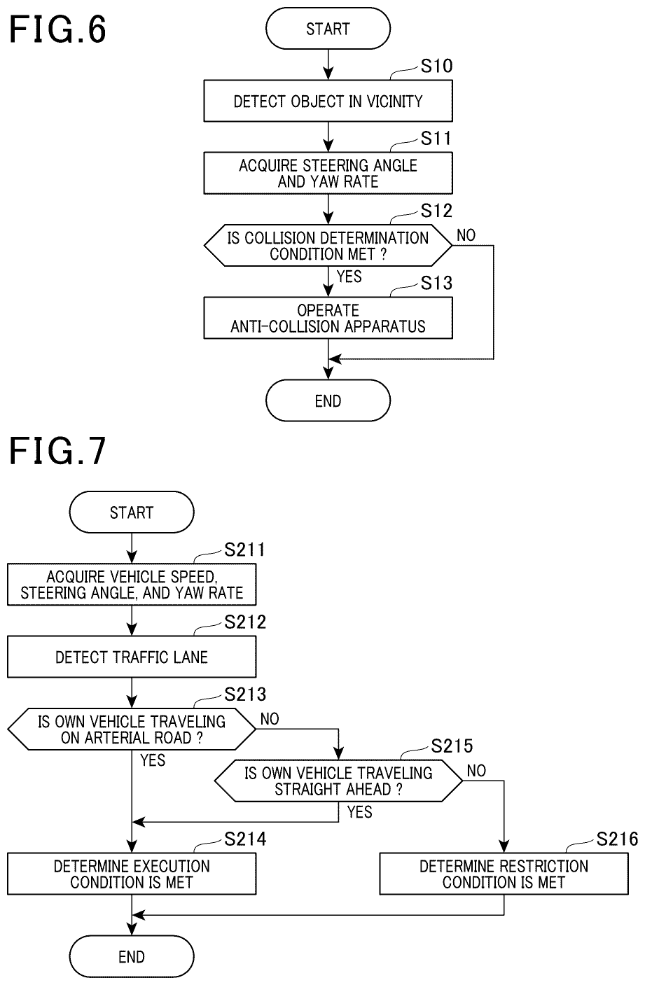

The vehicle control apparatus 100 updates the restriction on the operation of the anti-collision apparatus 400 while traveling by repeating the process above. Furthermore, the vehicle control apparatus 100 repeatedly performs a determination process for the operation of the anti-collision apparatus 400 shown in FIG. 6 while the own vehicle 10 is traveling.

At step S10 in FIG. 6, the vehicle control apparatus 10 detects the object Ob in the vicinity of the own vehicle 10. More specifically, the vehicle control apparatus 100 acquires the relative speed, the relative position, and the movement path of the object Ob in the vicinity of the own vehicle 10 by the object detection unit 200.

At step S11 in FIG. 6, the vehicle control apparatus 100 acquires the measurement values that are the steering angle and the yaw rate of the own vehicle 10 by the first acquisition unit 500.

At step S12 in FIG. 6, the vehicle control apparatus 100 determines whether the collision determination condition is met. When determined that the collision determination condition is met, the vehicle control apparatus 100 advances the process to step S13. When determined that the collision determination condition is not met, the vehicle control apparatus 100 ends the process. When the process is ended, the vehicle control apparatus 100 does not permit operation of the anti-collision apparatus 400.

The collision determination condition is a condition based on a relative collision time. The vehicle control apparatus 100 determines an advancing direction of the own vehicle 10 based on the steering angle and the yaw rate. The vehicle control apparatus 100 determines the relative collision time if the movement path of the object Ob in the vicinity of the own vehicle 10 intersects with the advancing direction of the own vehicle 10. The relative collision time is an amount of time obtained by the relative distance between the own vehicle and the object Ob in the vicinity of the own vehicle 10 being divided by the relative speed. Here, the vehicle control apparatus 100 determines the relative collision time based on the relative distance and the relative speed respectively measured by the object detection camera 210 and the radar apparatus 220.

For example, the vehicle control apparatus 100 may determine that likelihood of a collision is high in cases in which the object Ob of which the relative collision time is less than a reference time prescribed in advance is present among the objects Ob of which the relative collision times have been determined. For example, the reference time may be experimentally set based on a braking time based on typical vehicle speed. The vehicle control apparatus 100 determines that the likelihood of a collision is low in cases in which the object Ob of which the relative collision time is less than the reference time prescribed in advance is not present among the objects Ob of which the relative collision times have been determined. That is, the collision determination condition is that the object Ob of which the relative collision time is less than the reference time prescribed in advance be present among the objects Ob of which the relative collision times have been determined.

When restricting the operation of the anti-collision apparatus 400, the vehicle control apparatus 100 may set the collision determination condition to be stricter, for example, than when not restricting the operation of the anti-collision apparatus 400. Specifically, the vehicle control apparatus 100 sets the reference time to a shorter amount of time.

At step S13 in FIG. 6, the vehicle control apparatus 100 operates the anti-collision apparatus 400. That is, the vehicle control apparatus 100 notifies the driver that a collision may occur through by warning apparatus 440 or decelerates the own vehicle 10 by the deceleration apparatus 410.

The control method of the vehicle control apparatus 100 above will be described in detail giving travel examples. Here, in the travel examples described below, the vehicle control apparatus 100 repeatedly performs the processes in FIG. 3 and FIG. 6.

First, the control method of the vehicle control apparatus 100 when the own vehicle 10 travels on the arterial road Wh, as in the first travel example C1 in FIG. 2, will be described. In the first travel example C1, a travel progression of the own vehicle 10 may be shown to be, for example, from a first time point Pc11 to a third time point Pc13. The vehicle 10 travels along the first lane L1 as indicated by arrow direction Dc11 at the first time point Pc11. Subsequently, at the second time point Pc12, the own vehicle 10 changes traffic lanes from the first lane L1 to the second lane L2 as indicated by arrow direction Dc12. Furthermore, at the third time point Pc13, the own vehicle 10 enters an intersection Is to make a right turn towards a second road Wac12 as indicated by arrow direction Dc13.

The boundary line BL ahead of the own vehicle 10 at the first time point Pc11 is a first boundary line BLc1 that is a thick line. The first lane L1 has the boundary line BL and one-way traffic. More specifically, the first lane L1 is a traffic lane L having a width W of 3.5 m. Therefore, because the divided roadway condition is met, the vehicle control apparatus 100 determines that the own vehicle 10 is traveling on the arterial road Wh at step S113 in FIG. 4. That is, the vehicle control apparatus 100 does not restrict the operation of the anti-collision apparatus 400 because the execution condition including the divided roadway condition being met is met.

Consequently, the vehicle control apparatus 100 according to the present embodiment can suppress non-operation of the anti-collision apparatus 400 when the divided roadway condition is met as in the arterial road Wh.

Next, the control method of the vehicle control apparatus 100 when the own vehicle 10 is traveling on the two-way roadway Lt, as in the second travel example C2 in FIG. 5, will be described. On the two-way roadway Lt, other vehicles Ve or persons H may be present on both sides of the road as on a side street. The second travel example C2 shows a state in which other vehicles Ve are stopped and persons H are present on both sides of the two-way roadway Lt. Furthermore, in the second travel example C2, an oncoming vehicle Veo relative to the own vehicle 10 is traveling. Arrow direction Dc2 Veo indicates a path of the oncoming vehicle Veo traveling towards the intersection Is (not shown in FIG. 5). Arrow direction Dc210 in FIG. 5 indicates the traveling path of the own vehicle 10. A predicted path D2Veov indicates a movement path of the oncoming vehicle Veo determined by the vehicle control apparatus 100 when the own vehicle 10 is traveling along arrow direction Dc210a.

In the second travel example C2, the own vehicle 10 travels along the two-way roadway Lt while turning to avoid the other vehicles Ve that are stopped and persons H as indicated by arrow direction Dc210 in FIG. 5. The oncoming vehicle Veo also travels while avoiding the other vehicles Ve that are stopped and persons H. Therefore, the own vehicle 10 and the oncoming vehicle Veo may temporarily face each other as indicated by the predicted path Dc2Veov while avoiding collisions. In such a case, if the operation of the anti-collision apparatus 400 is not restricted, at step S12 in FIG. 6, the vehicle control apparatus 100 may operate the anti-collision apparatus 400 because the relative collision time is short. However, on the two-way roadway Lt, the own vehicle 10 and the oncoming vehicle Veo face each other while avoiding collisions and are unlikely to collide. That is, on the two-way roadway Lt, unnecessary operation of the anti-collision apparatus 400 tends to occur.

However, on the two-way roadway Lt, the vehicle control apparatus 100 determines that the restricting condition including the divided roadway condition not being met is met at step S110 in FIG. 3. Therefore, the vehicle control apparatus 100 performs restriction control to restrict operation of the anti-collision apparatus 400. Therefore, the vehicle control apparatus 100 can suppress unnecessary operation of the anti-collision apparatus 400 when the divided roadway condition is not met, such as on the two-way roadway Lt that is not the arterial road Wh.

Here, in the second travel example C2 in FIG. 5, the boundary line BL is drawn. However, even if the boundary line BL is not drawn, the divided roadway condition is not met. Therefore, the vehicle control apparatus 100 can suppress unnecessary operation of the anti-collision apparatus 400 even on the two-way roadway Lt on which the boundary line BL is not drawn.

That is, the vehicle control apparatus 100 according to the present embodiment restricts operation of the anti-collision apparatus 400 by restriction control. For example, the anti-collision apparatus 400 may automatically perform deceleration of the own vehicle 10. The anti-collision apparatus 400 that is in a state in which operation is restricted is less easily operated than the anti-collision apparatus 400 that is in a state in which operation is not restricted, as a result of conditions for operation becoming stricter, for example.

A case in which the divided roadway condition is met may be, for example, a case in which the traffic lane L has the boundary line BL and one-way traffic, such as the arterial road Wh. A case in which the divided roadway condition is not met may be, for example, a case in which the road is the two-way roadway Lt that has the boundary line BL. When the divided roadway condition is not met, the likelihood of other vehicles Ve and persons H being present on the road is high. As a result, because the own vehicle 10 is likely to travel while swerving to avoid the other vehicles Ve, persons H, and the like, unnecessary operation of the anti-collision apparatus 400 tends to occur.

Consequently, the vehicle control apparatus 100 according to the present embodiment can suppress unnecessary operation of the anti-collision apparatus 400. However, the vehicle control apparatus 100 according to the present embodiment can suppress non-operation when the divided roadway condition is met. Consequently, the vehicle control apparatus 100 according to the present embodiment can appropriately operate the anti-collision apparatus 400 based on the traveling conditions of the own vehicle 10.

### B. Second Embodiment

According to the above-described embodiment, the restriction condition includes the divided roadway condition not being met. However, the restriction condition may further include the measurement value acquired by the first acquisition unit 500 being greater than a first threshold. The vehicle control apparatus 100 performs a determination process for the restriction condition according to a second embodiment shown in FIG. 7.

The determination process for the restriction condition according to the second embodiment will be described below. Here, a configuration according to the second embodiment is identical to that according to the first embodiment. Furthermore, the vehicle control apparatus 100 according to the second embodiment performs the process in a manner similar to the vehicle control apparatus 100 according to the first embodiment unless stated otherwise. More specifically, the vehicle control apparatus 100 according to the second embodiment performs the determination process for the restriction condition at step S110 in the flowchart in FIG. 3 along a flowchart in FIG. 7 instead of the flowchart in FIG. 4.

At S211 in FIG. 7, the vehicle control apparatus 100 according to the second embodiment acquires the measurement value that is the steering angle and the yaw rate of the own vehicle 19 by the first acquisition unit 500. In addition, the vehicle control apparatus 100 acquires the vehicle speed by the second acquisition unit 600.

The process at step S212 in FIG. 7 is identical to the process at step S112 in FIG. 4.

At step S213 in FIG. 7, the vehicle control apparatus 100 according to the second embodiment determines whether the own vehicle 10 is traveling on the arterial road Wh. The determination is performed in manner similar to that according to the first embodiment. When determined that the divided roadway condition is met, the vehicle control apparatus 100 according to the second embodiment advances the process to step S214. When determined that the divided roadway condition is not met, the vehicle control apparatus advances the process to step S215.

The process at step S214 in FIG. 7 is identical to the process at step S114 in FIG. 4.

At step S215 in FIG. 7, the vehicle control apparatus 100 according to the second embodiment determines whether the own vehicle 100 is traveling straight ahead. More specifically, the vehicle control apparatus 100 according to the second embodiment advances the process to step S214 when the measurement value acquired from the first acquisition unit 500 is equal to or less than the first threshold prescribed in advance. When the measurement value exceeds the first threshold prescribed in advance, the vehicle control apparatus 100 according to the second embodiment advances the process to step S216.

A case in which the divided roadway condition is not met includes a case in which the boundary line BL is not detected. A case in which the boundary line BL is not detected specifically includes a case in which the road is the two-way roadway Lt that does not have the boundary line BL, as in the state in which the boundary line BL is not present in the second travel example C2 in FIG. 5, or the arterial road Wh in which the boundary line BL is interrupted. The operation of the anti-collision apparatus 400 is required to be restricted on the two-way roadway Lt but required to be enabled on the arterial road Wh, as described above. Because the lane width is narrower on the arterial road Wh than the two-way roadway Lt, a degree of turning of the vehicle 10 is likely to be greater when the own vehicle 10 swerves on the two-way roadway Lt than on the arterial road Wh.

Therefore, for example, the first threshold may be experimentally set based on an average measurement value acquired in the own vehicle 10 that travels straight ahead while swerving to avoid objects OB on both sides of the traffic lane L on the two-way roadway Lt as in the second travel example C2. That is, when determined that the measurement value is equal to or less than the first threshold, the vehicle control apparatus 100 determines that the own vehicle 10 is traveling straight head. When determined that the measurement value exceeds the first threshold, the vehicle control apparatus 100 determines that the own vehicle 10 is not traveling straight ahead. The determination method will be described in further detail below.

More specifically, the first threshold is configured by a threshold for each of the steering angle and the yaw rate. In addition, the steering angle and the yaw rate vary toward positive and negative sides as a result of the own vehicle 10 turning to the left and right. Therefore, the first threshold is composed of a positive-side threshold and a negative-side threshold.

Variations in the measurement value may differ between when the own vehicle 10 is traveling straight ahead while swerving and when the own vehicle 10 is turning along a road. When the own vehicle 10 is traveling straight ahead while swerving as in the second travel example C2, after starting a turn, the own vehicle 10 is required to turn the own vehicle 10 in a direction opposite the direction at the start of the turn to return the advancing direction to an initial advancing direction. However, when the own vehicle 10 turns along a road, the own vehicle 10 is not required to return the advancing direction to the initial advancing direction. That is, the measurement value when the own vehicle 10 advances straight ahead while swerving is likely to vary over a shorter amount of time than when the own vehicle 10 turns along a road.

Therefore, the vehicle control apparatus 100 determines that the measurement value is equal to or less than the first threshold prescribed in advance when conditions a1 to a3 below are met.

The vehicle control apparatus 100 according to the second embodiment compares the steering angle of the measurement value to the threshold of the steering angle in the first threshold and compares the yaw rate of the measurement value to the threshold of the yaw rate in the first threshold. The vehicle control apparatus 100 determines that the measurement value is equal to or less than the first threshold prescribed in advance if the conditions a1 to a3 described below are met, as conditions for determining that the own vehicle is traveling straight ahead.

<Conditions for Determining that the Own Vehicle is Traveling Straight Ahead>.
As a condition for determining that the own vehicle 10 is traveling straight ahead, the vehicle control apparatus 100 according to the second embodiment determines that both the steering angle and the yaw rate are equal to or less than the respective thresholds (condition a1).
In addition, the vehicle control apparatus 100 according to the second embodiment determines that the measurement value is equal to or less than either of the positive-side threshold and the negative-side threshold of the first threshold (condition a2).
Furthermore, the vehicle control apparatus 100 according to the second embodiment determines that a state in which the measurement value is greater than the first threshold has not continued for a period of time that is a variation reference time prescribed in advance (condition a3).

The above-described conditions a1 to a3 are summarized in Table 1 as follows.

TABLE 1

| | |
|---|---|
| Condition a1 | Both a steering angle and a yaw rate are equal |
| | to or less than respective thresholds |
| Condition a2 | A measurement value is equal to or less than |
| | either of a positive-side threshold and a |
| | negative-side threshold of the first threshold |
| Condition a3 | A state in which a measurement value is greater |
| | than a first threshold has not continued for a |
| | period of time that is a variation reference |
| | time prescribed in advance |

For example, the variation reference time may be experimentally set based on an average amount of time required to return to the advancing direction after the start of a turn to the advancing direction at the start of the turn, when the own vehicle 10 swerves to avoids another vehicle Ve, a person H, or the like.

That is, the vehicle control apparatus 100 according to the second embodiment determines that the own vehicle 10 is traveling straight ahead when, as a result of comparison between the measurement value and the first threshold, the above-described conditions a1 to a3 are met, that is, the measurement value is determined to be equal to or less than the first threshold. The vehicle control apparatus 100 then advances the process to step S214.

Meanwhile, the vehicle control apparatus 100 according to the second embodiment determines that the own vehicle 10 is not traveling straight ahead when at least one of the above-described conditions a1 to a3 is not met, that is, when the measurement value exceeds the first threshold prescribed in advance. The vehicle control apparatus 100 then advances the process to step S216.

The process at step S216 in FIG. 7 is identical to the process at step S115 in FIG. 4.

As a result of this aspect, the vehicle control apparatus 100 according to the present embodiment restricts the operation of the anti-collision apparatus 100 when the measurement value is greater than the first threshold when the divided roadway condition is not met. A case in which the divided roadway condition is not met includes the two-way roadway Lt that does not have the boundary line BL. For example, the vehicle control apparatus 100 according to the present embodiment may set the first threshold based on the measurement value for turning on the two-way roadway Lt. As a result, the vehicle control apparatus 100 according to the present embodiment restricts operation of the anti-collision apparatus 400 on a road on which unnecessary operation of the anti-collision apparatus 400 tends to occur even when the boundary line BL is not present. That is, the vehicle control apparatus 100 according to the present embodiment can suppress unnecessary operation of the anti-collision apparatus 400.

Furthermore, the vehicle control apparatus 100 according to the present embodiment does not restrict operation of the anti-collision apparatus 400 in the case of the arterial road Wh in which the boundary line BL is interrupted by determining that the own vehicle 10 is traveling straight ahead. That is, non-operation of the anti-collision apparatus 400 is suppressed.

### C. Third Embodiment

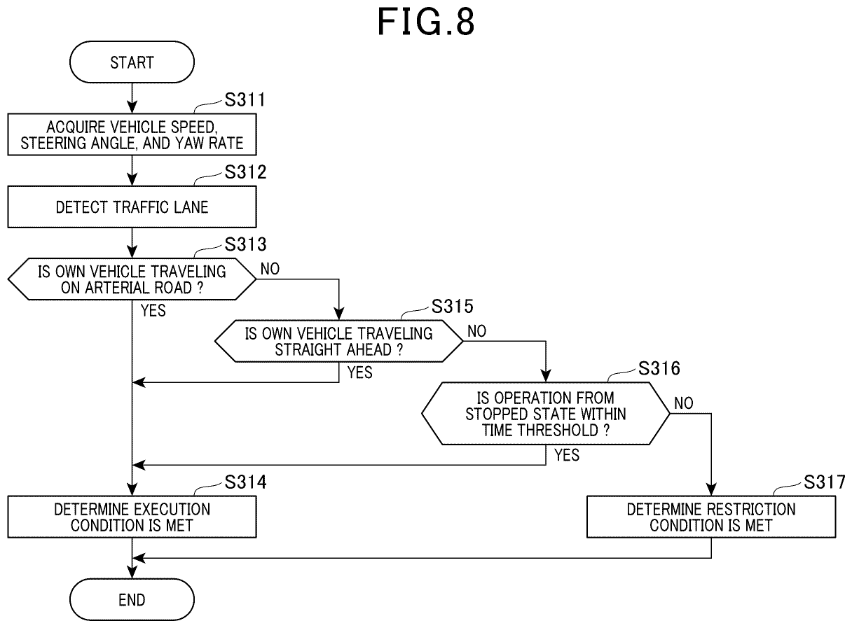

The restriction condition according to a third embodiment may further include, in addition to the restriction condition according to the second embodiment, an acceleration time from when the own vehicle 10 stops being greater than a time threshold prescribed in advance. The vehicle control apparatus 100 according to the third embodiment performs a determination process for the restriction condition according to the third embodiment shown in FIG. 8.

The determination process for the restriction condition according to the third embodiment will be described below. Here, a configuration according to the third embodiment is identical to the configuration according to the first embodiment. Furthermore, the vehicle control apparatus 100 according to the third embodiment performs the process in manner similar to the vehicle control apparatus 100 according to the second embodiment unless stated otherwise. More specifically, the vehicle control apparatus 100 according to the third embodiment performs the determination process for the restriction condition at step S110 in the flowchart in FIG. 3 along a flowchart in FIG. 8 instead of the flowchart in FIG. 7.

Processes at step S311 and step S312 in FIG. 8 are identical to the processes at step S211 and step S212 in FIG. 7.

At step S313 in FIG. 8, the vehicle control apparatus 100 according to the third embodiment determines whether the own vehicle 10 is traveling on the arterial road Wh. This determination is performed similarly to that according to the first embodiment. When determined that the divided roadway condition is met, the vehicle control apparatus 100 according to the third embodiment advances the process to step S314. When determined that the divided roadway condition is not met, the vehicle control apparatus 100 according to the third embodiment advances the process to step S315.

A process at step S314 in FIG. 8 is identical to the process at step S214 in FIG. 7.

At step S315 in FIG. 8, the vehicle control apparatus 100 according to the third embodiment determines whether the own vehicle 10 is traveling straight ahead. The determination is performed similarly to that according to the second embodiment. When determined that the measurement value is equal to or less than the first threshold prescribed in advance, the vehicle control apparatus 100 according to the third embodiment advances the process to step S314. When determined that the measurement value exceeds the first threshold prescribed in advance, the vehicle control apparatus 100 according to the third embodiment advances the process to step S316.

At step S316 in FIG. 8, the vehicle control apparatus 100 according to the third embodiment determines whether an operation from the state in which the own vehicle is stopped is within a time threshold. More specifically, when determined that an acceleration time from when the own vehicle 10 stops exceeds the time threshold prescribed in advance, the vehicle control apparatus 100 according to the third embodiment advances the process to step S317. When determined that the acceleration time from when the own vehicle 10 stops is equal to or less than the time threshold prescribed in advance, the vehicle control apparatus 100 according to the third embodiment advances the process to step S314.

The acceleration time is an amount of time required from start of acceleration from a stopped state until acceleration is ended. When the own vehicle 10 turns at the intersection Is, the own vehicle 10 may stop within the intersection Is to avoid a collision with the object Ob, such as an oncoming vehicle Veo or a person H. When a collision with the object Ob is unlikely, the own vehicle 10 accelerates and exits the intersection Is. For example, the time threshold may be experimentally set based on an average amount of time from when the own vehicle 10 stops at the intersection Is until acceleration is ended.

Here, when the own vehicle 10 is not stopped, the vehicle control apparatus 100 according to the third embodiment determines that the acceleration time is equal to or less than the time threshold.

A process at step S317 in FIG. 8 is identical to the process at step S115 in FIG. 4.

That is, when the divided roadway condition is not met and the measurement value is greater than the first threshold, if the acceleration time is less than the time threshold, the operation of the anti-collision apparatus 400 is not restricted. A case in which the divided roadway condition is not met may include, for example, the intersection Is as the road in which the boundary line BL is not present. In the intersection Is, the operation of the anti-collision apparatus 400 is required to suppress a collision with the oncoming vehicle Veo. For example, the vehicle control apparatus 100 according to the present embodiment may prescribe an average amount of time until the vehicle 10 finishes acceleration at the intersection Is. As a result, when the own vehicle 10 starts up from a stopped state, such as at the intersection Is, the vehicle control apparatus 100 according to the present embodiment does not restrict operation of the anti-collision apparatus 400. That is, the vehicle control apparatus 100 according to the present embodiment can suppress non-operation of the anti-collision apparatus 400 at the intersection Is.

### D. Fourth Embodiment

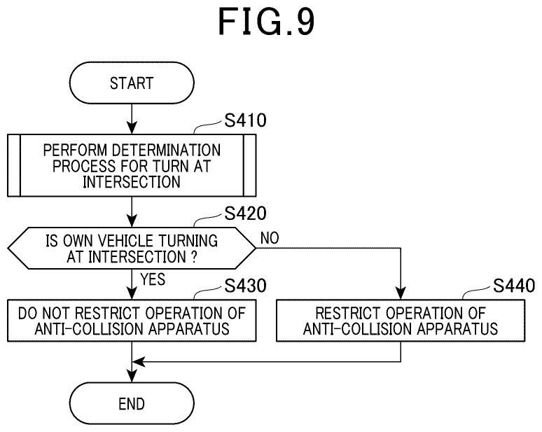

The vehicle control apparatus 100 according to a fourth embodiment determines whether the own vehicle 10 turns at the intersection Is based on a result of determination of the restriction condition. Here, a configuration according to the fourth embodiment is identical to that according to the first embodiment. Furthermore, the vehicle control apparatus 100 according to the fourth embodiment performs a process shown in FIG. 9 instead of that in FIG. 3 according to the first embodiment.

At step S410 in FIG. 9, the vehicle control apparatus 100 according to the fourth embodiment determines whether the own vehicle 10 is turning at the intersection Is. The determination at step S410 is referred to as a turning determination process at the intersection Is.

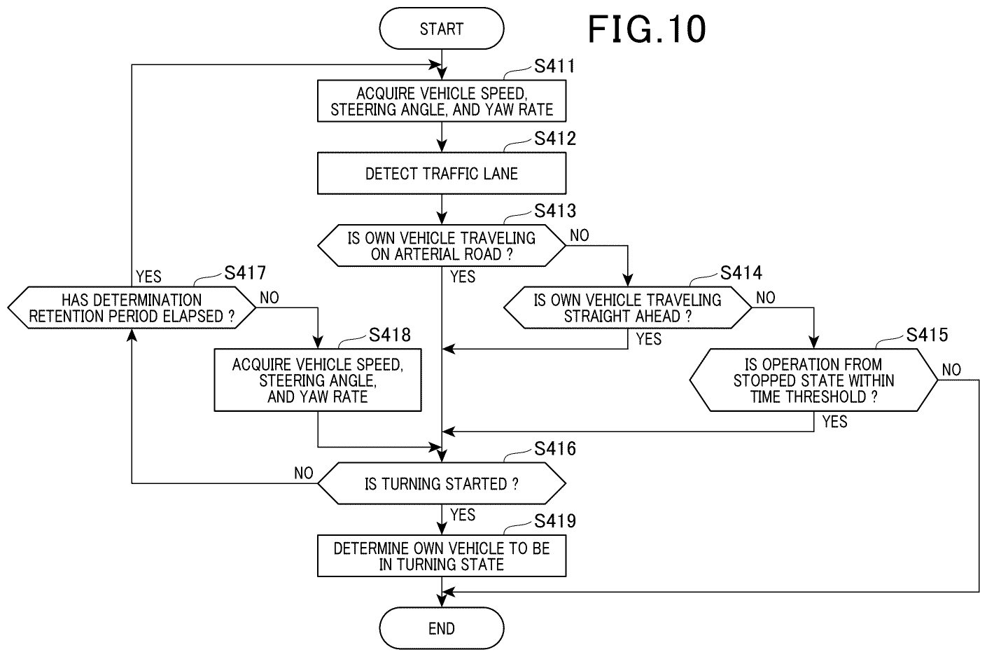

The vehicle control apparatus 100 according to the fourth embodiment performs the turning determination process at the intersection Is shown in FIG. 10. Processes at step S411 and step S412 in FIG. 10 are identical to the processes at step S311 and step S312 in FIG. 8.

In a process at step S413 in FIG. 10, the vehicle control apparatus 100 according to the fourth embodiment determines whether the own vehicle 10 is traveling on the arterial road Wh. The determination is performed in a manner similar to step S313 in FIG. 8. When determined that the divided roadway condition is met, the vehicle control apparatus 100 according to the fourth embodiment advances the process to step S416. When determined that the divided roadway condition is not met, the vehicle control apparatus 100 according to the fourth embodiment advances the process to step S414.

At step S414 in FIG. 10, the vehicle control apparatus 100 according to the fourth embodiment determines whether the own vehicle 10 is traveling straight ahead. The determination is performed in a manner similar to step S315 in FIG. 8. When determined that the measurement value is equal to or less than the first threshold prescribed in advance, the vehicle control apparatus 100 according to the fourth embodiment advances the process to step S416. When determined that the measurement value exceeds the first threshold, the vehicle control apparatus 100 according to the fourth embodiment advances the process to step S415.

At step S416 in FIG. 8, the vehicle control apparatus 100 according to the fourth embodiment determines whether the operation from the state in which the own vehicle 10 is stopped is within the time threshold. The determination is performed in a manner similar to step S316 in FIG. 8. When determined that the acceleration time from when the own vehicle 10 stops is equal to or less than the time threshold prescribed in advance, the vehicle control apparatus 100 according to the fourth embodiment advances the process to step S416. When the acceleration time from when the own vehicle 10 stops exceeds the time threshold prescribed in advance, the vehicle control apparatus 100 according to the fourth embodiment ends the process.

That is, step S411 to step S415 in FIG. 10 are processes similar to the determination process for the restriction condition.

At step S416 in FIG. 10, the vehicle control apparatus 100 according to the fourth embodiment determines whether the own vehicle 10 has started turning. More specifically, when determined that the measurement value acquired by the first acquisition unit 500 exceeds a second threshold prescribed in advance during a determination retention period, the vehicle control apparatus 100 according to the fourth embodiment advances the process to step S419. That is, the vehicle control apparatus 100 according to the fourth embodiment advances the process to step S419 when the own vehicle 10 has started turning.

When determined that the measurement value acquired by the first acquisition unit 500 is equal to or less than the second threshold prescribed in advance during the determination retention period, the vehicle control apparatus 100 according to the fourth embodiment advances the process to step S417. That is, the vehicle control apparatus 100 according to the fourth embodiment advances the process to step S417 when the own vehicle 10 has not started turning.

The determination retention period is prescribed based on an amount of time required for the own vehicle 10 to start turning after entering the intersection Is, with time at which the divided roadway condition is met being a starting point. The determination retention period is a period during which the determination that the divided roadway condition is met is retained. For example, a length of the determination retention period is experimentally set based on the amount of time required for the own vehicle 10 to start turning from when the own vehicle 10 enters the intersection Is, depending on the vehicle speed. The vehicle control apparatus 100 according to the fourth embodiment performs the determination at step S416 during the determination retention period based on the acquired vehicle speed. Therefore, even if the boundary line BL no longer is detectable during the determination retention period, the vehicle control apparatus 100 according to the fourth embodiment retains the determination that the divided roadway condition is met.

The comparison between the measurement value and the second threshold is performed in a manner similar to the comparison between the measurement value and the first threshold according to the second embodiment. However, for example, the second threshold is experimentally set based on an average measurement value obtained from left and right turns of the own vehicle 10 at the intersection Is. For example, the variation reference time of the second threshold is also similarly experimentally set based on the average amount of time required for variations as a result of left and right turns of the own vehicle 10 at the intersection Is.

At step S417 in FIG. 10, the vehicle control apparatus 100 according to the fourth embodiment determines whether the determination retention period has elapsed. When determined that the determination retention period has not elapsed, the vehicle control apparatus 100 according to the fourth embodiment advances the process to step S418. When determined that the determination retention period has elapsed, the vehicle control apparatus 100 according to the fourth embodiment returns the process to step S411.

A process at step S418 in FIG. 10 is identical to the process at step S411.

At step S419 in FIG. 10, the vehicle control apparatus 100 according to the fourth embodiment determines that the own vehicle 10 is turning at the intersection Is. A state in which the own vehicle 10 is turning at the intersection Is is referred to as a turning state.

The turning determination process at the intersection Is is thereby ended.

At step S420 in FIG. 9, the vehicle control apparatus 100 according to the fourth embodiment determines whether the own vehicle 10 is turning at the intersection Is based on the turning determination process at the intersection Is at step S410. That is, when determined that the own vehicle 10 is in the turning state, the vehicle control apparatus 100 according to the fourth embodiment advances the process to step S430. When determined that the own vehicle 10 is not in the turning state, the vehicle control apparatus 100 according to the fourth embodiment advances the process to step S440.

The control method of the vehicle control apparatus 100 according to the fourth embodiment will be described in detail giving travel examples. In the travel examples described below, the vehicle control apparatus 100 repeatedly performs the processes in FIG. 6 and FIG. 9.

At the first time point Pc11 in the first travel example C1 in FIG. 2, the vehicle control apparatus 100 according to the fourth embodiment determines that the divided roadway condition is met at step S413 in FIG. 10 because the own vehicle 10 is on the arterial road Wh. Therefore, at step S416 in FIG. 10, the vehicle control apparatus 10 determines whether turning is started. Because the own vehicle 10 is traveling in the first lane L1 and the measurement value does not exceed the second threshold, the vehicle control apparatus 100 according to the fourth embodiment does not determine that the own vehicle 10 is in the turning state. Subsequently, the vehicle control apparatus 100 according to the fourth embodiment repeatedly performs the turning determination process at the intersection Is again. Therefore, the operation of the anti-collision apparatus 400 is not restricted.

At the second time point Pc12, the own vehicle 10 changes traffic lanes. Therefore, although the traffic lane L in which the own vehicle 10 is traveling is undetermined, the vehicle control apparatus 100 according to the fourth embodiment determines that the divided roadway condition is met during the determination retention period from the first time point Pc11. Therefore, at step S416 in FIG. 10, the vehicle control apparatus 100 according to the fourth embodiment determines whether turning is started. The vehicle control apparatus 100 according to the fourth embodiment does not determine that the own vehicle 10 to be in the turning state because the measurement value does not exceed the second threshold in the case of turning due to lane change. Subsequently, the vehicle control apparatus 100 according to the fourth embodiment repeats the turning determination process at the intersection Is again. Therefore, the operation of the anti-collision apparatus 400 is not restricted.

At the third time point Pc13, the own vehicle 13 enters the intersection Is. The boundary line BL is not detected in the intersection Is. However, the vehicle control apparatus 100 according to the fourth embodiment determines that the divided roadway condition is met during the determination retention period immediately after the own vehicle 10 enters the intersection Is. Therefore, at step S416 in FIG. 10, the vehicle control apparatus 100 according to the fourth embodiment determines whether the turning is started. The vehicle control apparatus 100 according to the fourth embodiment determines that the own vehicle 10 is in the turning state because the measurement value exceeds the second threshold as a result of the own vehicle 10 turning at the intersection Is. Therefore, the vehicle control apparatus 100 according to the fourth embodiment does not restrict the operation of the anti-collision apparatus 400 at step S430 in FIG. 9.

That is, the vehicle control apparatus 100 according to the present embodiment does not restrict the operation of the anti-collision apparatus 400 as a result of the own vehicle 10 turning when the own vehicle 10 enters the intersection Is that has no boundary lines Bl immediately after the divided roadway condition is met. For example, to restrict operation of the anti-collision apparatus 400 in the intersection Is by another method, the vehicle control apparatus 100 is required to determine that the vehicle 10 is in the intersection Is. For example, as the method for determining that the own vehicle 10 is in the intersection Is, the own vehicle 10 can be determined to be in the intersection Is based on the own vehicle 10 traveling straight ahead before entering the intersection Is and turning thereafter. However, if the own vehicle 10 turns before entering the intersection Is, determining that the own vehicle 10 is in the intersection Is is difficult.

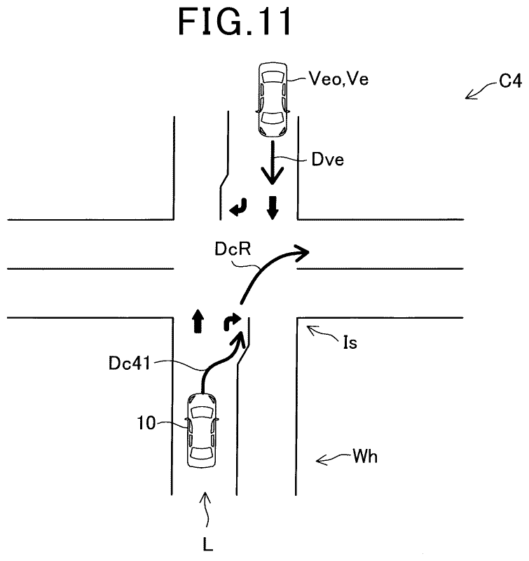

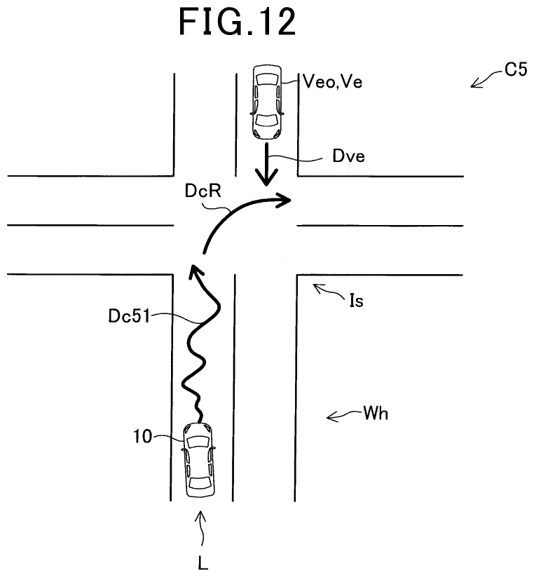

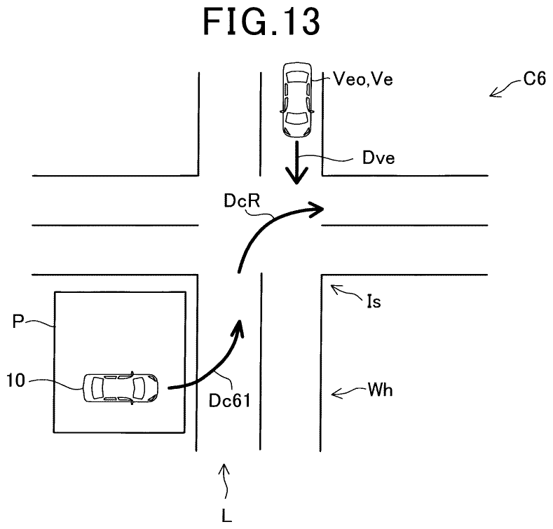

For example, regarding turning of the own vehicle 10 before entering the intersection Is, examples such as fourth travel example C4 to sixth travel example C6 shown in FIG. 11 to FIG. 13 can be assumed. In FIG. 11 to FIG. 13, as indicated by arrow direction DcR, the own vehicle 10 is in a state of turning right at the intersection Is. The own vehicle 10 in the fourth travel example C4 in FIG. 11 turns before entering the intersection Is to change lanes to a right-turn lane as indicated by arrow direction Dc41. The own vehicle 10 in the fifth travel example C5 in FIG. 12 drives in a swerving manner inside the traffic lane L as indicated by arrow direction Dc51 before entering the intersection Is. This swerving may occur as during path correction or due to driving skills, inattentive driving, and the like. The own vehicle 10 in the sixth traveling example in FIG. 13 enters the traffic lane L while turning before entering the intersection Is as indicated by arrow direction Dc61. For example, this traveling occurs when the own vehicle 10 enters the traffic lane L leading to the intersection Is from a parking facility P or a road near the intersection Is.

Therefore, the vehicle control apparatus 100 according to the present embodiment can determine that the own vehicle 10 is turning at the intersection Is regardless of the turning state before entering the intersection Is. Consequently, the vehicle control apparatus 100 according to the present embodiment can appropriately suppress non-operation of the anti-collision apparatus 100 at the intersection Is compared to an aspect in which the anti-collision apparatus 400 is controlled based on the turning state of the own vehicle 10 before entering the intersection.

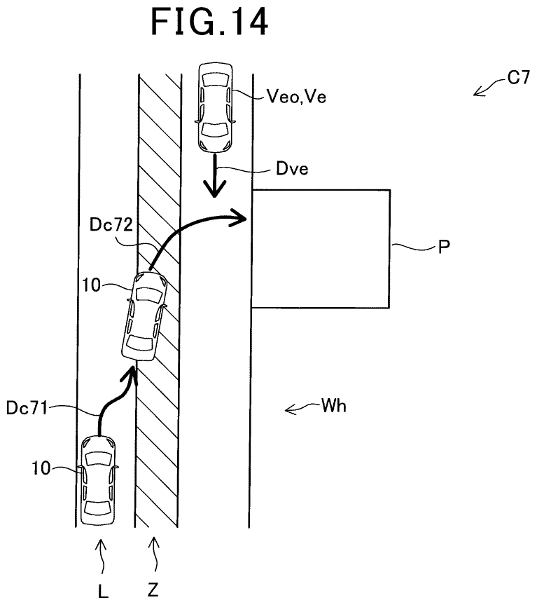

Here, the vehicle control apparatus 100 does not restrict the operation of the anti-collision apparatus 400 even when turning at a same extent as the intersection Is immediately after the divided roadway condition is met, regardless of the intersection Is. For example, as shown in FIG. 14, the own vehicle 40 in a seventh travel example C7 turns right and enters the parking facility P after entering a zebra zone (hatched zone) Z from the arterial road Wh as indicated by the arrow direction Dc71. As indicated by the arrow direction Dc72, the own vehicle 10 enters the zebra zone Z while turning. However, even in such a case, the vehicle control apparatus 100 according to the present embodiment does not restrict the operation of the anti-collision apparatus 400 when turning right to enter the parking facility P if the turn is during the determination retention period. That is, the vehicle control apparatus 100 according to the present embodiment can suppress non-operation of the anti-collision apparatus 400.

### E. Fifth Embodiment

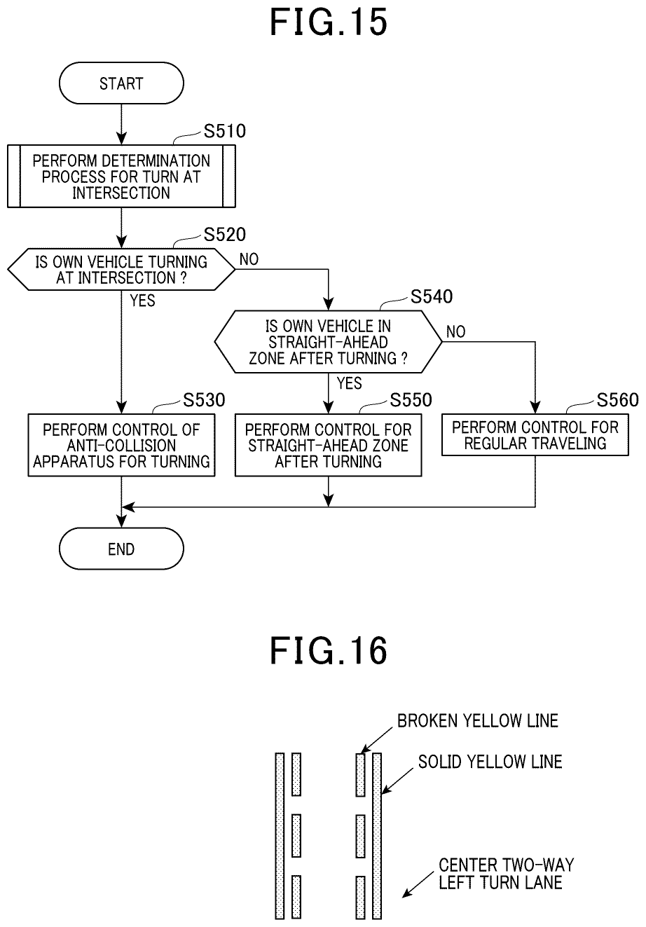

The vehicle control apparatus 100 may control the anti-collision apparatus 400 based on the own vehicle 10 being mid-turn or in a straight-ahead zone after turning. Here, a configuration according to the fifth embodiment is identical to that according to the first embodiment. Furthermore, the vehicle control apparatus 100 according to the fifth embodiment performs processes similar to those of the vehicle control apparatus 100 according to the fourth embodiment. The vehicle control apparatus 100 according to the fifth embodiment performs processes in FIG. 15 instead of the processes shown in FIG. 9.

A process at step S510 in FIG. 15 is identical to the process at step S410 in FIG. 9.

At step S520 in FIG. 15, the vehicle control apparatus 100 according to the fifth embodiment determines whether the own vehicle 10 has started turning. More specifically, when determined that the measurement value exceeds the second threshold prescribed in advance during the determination retention period, the vehicle control apparatus 100 according to the fifth embodiment advances the process to step S530. When determined that the measurement value is equal to or less than the second threshold prescribed in advance during the determination retention period, the vehicle control apparatus 100 according to the fifth embodiment advances the process to step S540.

At step S530 in FIG. 15, the vehicle control apparatus 100 according to the fifth embodiment performs control for mid-turn. As a result of control for mid-turn, as described according to the first embodiment, the anti-collision apparatus 400 is controlled based on the collision determination condition using the relative collision time.

At step S540 in FIG. 15, the vehicle control apparatus 100 according to the fifth embodiment determines whether the own vehicle 10 is in the straight-ahead zone after turning. For example, a determination condition for whether the own vehicle is in the straight-ahead zone after turning includes at least one of conditions b1 to b4 below.

<Conditions for Determining Whether the Own Vehicle is in the Straight-Ahead Zone after Turning>
In a manner similar to the process at step S316 according to the third embodiment, operation from the state in which the own vehicle 10 is stopped exceeds a time threshold (condition b1).
The steering angle, a steering angle velocity, or the yaw rate increases by an amount equal to or greater than an amount prescribed in advance in a direction opposite a turning direction at the intersection Is (condition b2).
The vehicle speed is zero (condition b3).
Steering by the driver is no longer necessary, such as during autonomous driving (condition b4).

The above-described conditions b1 to b4 are summarized in Table 1, as follows.

TABLE 2

| | |
|---|---|
| Condition b1 | Operation from a state in which an own vehicle |
| | is stopped exceeds a time threshold |
| Condition b2 | A steering angle, a steering angle velocity, |
| | or a yaw rate increases by anamount equal to or |
| | greater than an amount prescribed in advance in a |
| | direction opposite a turning direction at the intersection |
| Condition b3 | A vehicle speed is zero |
| Condition b4 | Steering by the driver is no longer necessary, |
| | such as during autonomous driving |

When all of the above-described determination conditions (i.e., conditions b1 to b4) are negated as a result of the above-described determination, the vehicle control apparatus 100 according to the fifth embodiment determines that the own vehicle 10 is in the straight-ahead zone after turning. As a result, the vehicle control apparatus 100 according to the fifth embodiment advances the process to step S550. When any of the above-described determination conditions (i.e., conditions b1 to b4) are affirmed, the vehicle control apparatus 100 according to the fifth embodiment determines that the own vehicle 10 has finished the straight-ahead zone after turning. As a result, the vehicle control apparatus 100 according to the fifth embodiment advances the process to step S560. Here, to acquire the steering angle velocity, the first acquisition unit 500 may acquire the steering angle velocity.

At step S550 in FIG. 15, the vehicle control apparatus 100 according to the fifth embodiment performs control for the straight-ahead zone after turning. As a result of control for the straight-ahead zone after turning, whether at least one of conditions c1 to c3 below is met is determined.

<Conditions for Determining Whether the Control for the Straight-Ahead Zone after Turning is to be Performed>
An estimated radius is equal to or less than a radius threshold (condition c1).
The steering angle is equal to or greater than a third threshold (condition c2).
The steering angle velocity is equal to or greater than a steering angle velocity threshold (condition c3).

The above-described conditions c1 to c3 are summarized in Table 3 as follows.

TABLE 3

| | |
|---|---|
| Condition c1 | An estimated radius is equal to or less than a |
| | radius threshold |
| Condition c2 | A steering angle is equal to or greater than a |
| | third threshold |
| Condition c3 | A steering angle velocity is equal to or greater |
| | than a steering angle velocity threshold |

When at least one of the conditions c1 to c3, above, is met as a result of the determination, the vehicle control apparatus 100 according to the fifth embodiment restricts operation of the anti-collision apparatus 100.

Upon completion of a turn, the driver may adjust the orientation of the own vehicle 10 by performing a turning operation in a direction opposite the turning direction. Swaying of the own vehicle 10 that occurs as a result is referred to as a counter-sway. Unnecessary operation due to counter-sway is suppressed by the process at step S550 in FIG. 15.

At step S560 in FIG. 15, the vehicle control apparatus 100 according to the fifth embodiment performs regular control. The operation of the anti-collision apparatus 400 is more strictly restricted by the regular control than the control for the straight-ahead zone after turning.

According to this aspect, the vehicle control apparatus 100 according to the present embodiment can apply the determination process for turning at the intersection Is even when the operation of the anti-collision apparatus 400 is controlled based on the own vehicle 10 being mid-turn or in the straight-ahead zone after turning.

### F. Other Embodiments

(1) In the travel examples according to the above-described embodiments, a state in which the own vehicle 10 turns right is shown. However, the vehicle control apparatus 100 performs the processes regardless of the own vehicle 10 turning left or right. More specifically, the vehicle control apparatus 100 determines the turning state by comparing the measurement value to the first threshold or the second threshold regardless of the own vehicle 10 turning left or right.

(2) According to the above-described embodiments, the radar apparatus 220 and the object detection camera 210 are provided to face ahead and the left and right directions. However, the radar apparatus 220 and the object detection camera 210 may be provided to face only ahead to detect only the objects Ob ahead.

(3) According to the above-described embodiments, the object detection unit 200 includes the object detection camera 210 and the radar apparatus 220. However, the object detection unit 220 is merely required to include at least either.

(4) According to the above-described embodiments, the lane detection camera 310 and the object detection camera 210 are configured by differing monocular cameras. However, the lane detection camera 310 may be configured by a portion of the monocular cameras of the object detection camera 210. Alternatively, the lane detection camera 310 and the object detection camera 210 may be configured by the same monocular camera.

(5) According to the above-described embodiments, the object detection unit 200 detects the object Ob by the object detection camera 210 and the radar apparatus 220. However, the object detection unit 200 may detect the object Ob in the vicinity of the own vehicle 10 by other methods. For example, the object detection unit 200 may detect the object in the vicinity of the own vehicle 10 by Light Detection And Ranging/Laser Imaging Detection and Ranging (LiDAR).

(6) According to the above-described embodiments, the anti-collision apparatus 400 includes the deceleration apparatus 410, the seatbelt 420, the warning apparatus 440, and the steering apparatus 430. However, the anti-collision apparatus 400 is merely required to include at least one of the deceleration apparatus 410, the seatbelt 420, the warning apparatus 440, and the steering apparatus 430.

(7) According to the second embodiment, the vehicle control apparatus 100 advances the process to step S214 when determined that the measurement value is equal to or less than the first threshold prescribed in advance. The vehicle control apparatus 100 advances the process to step S216 when determined that the measurement value exceeds the first threshold prescribed in advance. However, the determination may be performed in a following manner. That is, the vehicle control apparatus 100 advances the process to step S214 when the determined that measurement value is less than the first threshold prescribed in advance. The vehicle control apparatus 100 advances the process to step S216 when determined that the measurement value is equal to or greater than the first threshold prescribed in advance. That is, the vehicle control apparatus 100 may determine that the restriction condition is met when the measurement value acquired by the acquisition unit is greater than the first threshold prescribed in advance.

(8) According to the above-described embodiments, the reference length is set based on vehicle speed. However, the reference length may not be based on vehicle speed. The reference length may be a fixed value.

(9) According to the third embodiment, the vehicle control apparatus 100 advances the process to step S317 when determined that the acceleration time from when the own vehicle 10 stops exceeds the time threshold prescribed in advance. The vehicle control apparatus 100 according to the third embodiment advances the process to step S314 when determined that the acceleration time from when the own vehicle 10 stops is equal to or less than the time threshold prescribed in advance. However, the vehicle control apparatus 100 may perform the determination in a following manner. The vehicle control apparatus 100 advances the process to step S317 when the determined that the acceleration time from when the own vehicle 10 stops is equal to or greater than the time threshold prescribed in advance. The vehicle control apparatus 100 according to the third embodiment advances the process to step S314 when determined that the acceleration time from when the own vehicle 10 stops is less than the time threshold prescribed in advance. That is, the vehicle control apparatus 100 may determine that the restriction condition is met when the acceleration time from when the own vehicle 10 stops is greater than the time threshold prescribed in advance.

(10) According to the third embodiment, the restriction condition includes the acceleration time from when the own vehicle 10 stops being greater than the time threshold prescribed in advance. However, instead of this condition, the restriction condition may include a wait time from when the own vehicle 10 stops being greater than a time threshold prescribed in advance. The wait time is an amount of time required for the own vehicle 10 to start accelerating from the stopped state. In this case, for example, the time threshold is experimentally set based on an average amount of time until the own vehicle 10 starts acceleration after stopping at the intersection Is. In this case, the vehicle control apparatus 100 does not restrict the operation of the anti-collision apparatus 400 when the own vehicle 10 starts traveling from a stopped state as in the intersection Is. That is, the vehicle control apparatus 100 of the present disclosure can suppress non-operation of the anti-collision apparatus 400 at the intersection Is.

(11) According to the above-described embodiments, the determination retention period is set based on vehicle speed. However, the determination retention period may not be based on vehicle speed. The determination retention period may be a fixed value.

(12) According to the above-described embodiments, as an aspect that can be determined to be a divided roadway (arterial road) by the vehicle control apparatus of the present disclosure, a center two-way left-turn lane that is used in the United States, as shown in FIG. 16, that is, a lane in which the boundary lines detected by the lane detection unit are composed of a broken yellow line and a solid yellow line, may be included.

(13) The control unit and a method thereof described in the present disclosure may be actualized by a dedicated computer that is provided such as to be configured by a processor and a memory, the processor being programmed to provide one or a plurality of functions that are realized by a computer program. Alternatively, the control unit and a method thereof described in the present disclosure may be actualized by a dedicated computer that is provided by a processor being configured by a single dedicated hardware logic circuit or more. As still another alternative, the control unit and a method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible computer-readable storage medium that can be read by a computer as instructions performed by the computer.

The present disclosure is not limited to the above-described embodiments and variation examples, and can be actualized by various configurations without departing from the spirit of the disclosure. For example, technical features according to embodiments and variation examples that correspond to technical features in each aspect described in the summary of the invention can be replaced and combined as appropriate to solve some or all of the above-described issued or to obtain some or all of the above-described effects. Furthermore, the technical features may be omitted as appropriate unless described as a requisite in the present specification.

### G. Other Aspects

Characteristics of the present disclosure are as follows:

### (First Aspect)

A vehicle control apparatus (100) that is mounted to a vehicle (10), the vehicle including an object detection unit (200) that detects an object (Ob) in a vicinity of the vehicle, an anti-collision apparatus (400) that controls the vehicle to suppress a collision between the vehicle and the object resulting from the vehicle moving, and a lane detection unit (300) that detects a boundary line (BL) demarcating a traffic lane (L) ahead of the vehicle, in which the vehicle control apparatus does not restrict operation of the anti-collision apparatus in response to an execution condition being met, and performs control restriction restricting operation of the anti-collision apparatus in response to a restriction condition being met, in which the execution condition includes a divided roadway condition being met, the divided roadway condition being a width (W) of the traffic lane determined based on the boundary line detected by the lane detection unit being less than a width of a traffic lane permitting two-way traffic, and the restriction condition includes the divided roadway condition not being met.

### (Second Aspect)

The vehicle control apparatus according to the first aspect, in which: the vehicle further includes a first acquisition unit (500) that acquires at least either of a steering angle and a yaw rate of the vehicle; and the restriction condition further includes a measurement value acquired by the first acquisition unit being greater than a first threshold prescribed in advance.

### (Third Aspect)

The vehicle control apparatus according to the second aspect, in which: the restriction condition further includes a wait time or an acceleration time from when the vehicle stops being greater than a time threshold prescribed in advance.

### (Fourth Aspect)

The vehicle control apparatus according to the third aspect, in which: the execution condition further includes the measurement value acquired by the first acquisition unit being greater than a second threshold prescribed in advance during a determination retention period based on an amount of time required for the vehicle to start turning after entering an intersection (Is), with time at which the divided roadway condition is met being a starting point.

### (Fifth Aspect)

The vehicle control apparatus according to the first aspect, in which: the execution condition further includes the boundary line detected by the boundary line detection unit being a center two-way left turn lane that is composed of a broken yellow line and a solid yellow line.

### (Sixth Aspect)

The vehicle control apparatus according to the first aspect, in which: a degree of restriction on the operation of the anti-collision apparatus is reduced in response to the vehicle being determined to be in a straight-ahead zone after turning.

### (Seventh Aspect)

A vehicle control apparatus (100) that is mounted to a vehicle (10), the vehicle including an object detection unit (200) that detects an object (Ob) in a vicinity of the vehicle, an anti-collision apparatus (400) that controls the vehicle to suppress a collision between the vehicle and the object resulting from the vehicle moving, and a lane detection unit (300) that detects a boundary line (BL) demarcating a traffic lane (L) ahead of the vehicle, wherein the vehicle control apparatus comprising: a processor: a non-transitory computer readable storage medium; a set of computer-executable instructions stored on the computer-readable storage medium that, when read and executed by the processor, cause the processor to implement: not restricting operation of the anti-collision apparatus in response to an execution condition being met, and performing control restriction restricting operation of the anti-collision apparatus in response to a restriction condition being met, in which the execution condition includes a divided roadway condition being met, the divided roadway condition being a width (W) of the traffic lane determined based on the boundary line detected by the lane detection unit being less than a width of a traffic lane permitting two-way traffic, and the restriction condition includes the divided roadway condition not being met.

### (Eighth Aspect)

A vehicle control method for a vehicle (10), the vehicle including an object detection unit (200) that detects an object (Ob) in a vicinity of the vehicle, an anti-collision apparatus (400) that controls the vehicle to suppress a collision between the vehicle and the object resulting from the vehicle moving, and a lane detection unit (300) that detects a boundary line (BL) demarcating a traffic lane (L) ahead of the vehicle, in which the vehicle control apparatus does not restrict operation of the anti-collision apparatus in response to an execution condition being met, and performs control restriction restricting operation of the anti-collision apparatus in response to a restriction condition being met, wherein the execution condition includes a divided roadway condition being met, the divided roadway condition being a width (W) of the traffic lane determined based on the boundary line detected by the lane detection unit being less than a width of a traffic lane permitting two-way traffic, and the restriction condition includes the divided roadway condition not being met.

What is claimed is:

1. A vehicle control apparatus that is mounted to a vehicle, the vehicle including an object detection unit that detects an object in a vicinity of the vehicle, an anti-collision apparatus that controls the vehicle to suppress a collision between the vehicle and the object resulting from the vehicle moving, and a lane detection unit that detects a boundary line demarcating a traffic lane ahead of the vehicle, wherein
the vehicle control apparatus
does not restrict operation of the anti-collision apparatus in response to an execution condition being met, and
performs control restriction restricting operation of the anti-collision apparatus in response to a restriction condition being met, wherein
the execution condition includes a divided roadway condition being met, the divided roadway condition being a width of the traffic lane determined based on the boundary line detected by the lane detection unit being less than a width of a traffic lane permitting two-way traffic, and
the restriction condition includes the divided roadway condition not being met.

2. The vehicle control apparatus according to claim 1, wherein:
the vehicle further includes a first acquisition unit that acquires at least either of a steering angle and a yaw rate of the vehicle; and
the restriction condition further includes a condition that a measurement value acquired by the first acquisition unit is greater than a first threshold prescribed in advance.

3. The vehicle control apparatus according to claim 2, wherein:
the restriction condition further includes a wait time or an acceleration time from when the vehicle stops being greater than a time threshold prescribed in advance.

4. The vehicle control apparatus according to claim 3, wherein:
the execution condition further includes the measurement value acquired by the first acquisition unit being greater than a second threshold prescribed in advance during a determination retention period based on an amount of time required for the vehicle to start turning after entering an intersection with time at which the divided roadway condition is met being a starting point.

5. The vehicle control apparatus according to claim 1, wherein:
the execution condition further includes the boundary line detected by the boundary line detection unit being a center two-way left turn lane that is composed of a broken yellow line and a solid yellow line.

6. The vehicle control apparatus according to claim 1, wherein:
a degree of restriction on the operation of the anti-collision apparatus is reduced in response to the vehicle being determined to be in a straight-ahead zone after turning.

7. A vehicle control apparatus that is mounted to a vehicle, the vehicle including an object detection unit that detects an object in a vicinity of the vehicle, an anti-collision apparatus that controls the vehicle to suppress a collision between the vehicle and the object resulting from the vehicle moving, and a lane detection unit that detects a boundary line demarcating a traffic lane ahead of the vehicle, wherein
the vehicle control apparatus comprising:
a processor:
a non-transitory computer readable storage medium;
a set of computer-executable instructions stored on the computer-readable storage medium that, when read and executed by the processor, cause the processor to implement:
not restricting operation of the anti-collision apparatus in response to an execution condition being met, and
performing control restriction restricting operation of the anti-collision apparatus in response to a restriction condition being met, wherein
the execution condition includes a divided roadway condition being met, the divided roadway condition being a width of the traffic lane determined based on the boundary line detected by the lane detection unit being less than a width of a traffic lane permitting two-way traffic, and
the restriction condition includes the divided roadway condition not being met.

8. A vehicle control method for a vehicle, the vehicle including an object detection unit that detects an object in a vicinity of the vehicle, an anti-collision apparatus that controls the vehicle to suppress a collision between the vehicle and the object resulting from the vehicle moving, and a lane detection unit (300) that detects a boundary line (BL) demarcating a traffic lane ahead of the vehicle, wherein
the vehicle control apparatus
does not restrict operation of the anti-collision apparatus in response to an execution condition being met, and
performs control restriction restricting operation of the anti-collision apparatus in response to a restriction condition being met, wherein
the execution condition includes a divided roadway condition being met, the divided roadway condition being a width of the traffic lane determined based on the boundary line detected by the lane detection unit being less than a width of a traffic lane permitting two-way traffic, and
the restriction condition includes the divided roadway condition not being met.
